(19) United States
(12) Patent Application Publication
(10) Pub. No.: US 2009/0035718 A1
(43) Pub. Date: Feb. 5, 2009

(54) DENTAL ISOLATION BLOCK

(76) Inventor: Logan Coffee, Vian, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/185,703

(22) Filed: Aug. 4, 2008

Related U.S. Application Data
(60) Provisional application No. 60/953,902, filed on Aug. 3, 2007.

(51) Int. Cl. A61C 17/10

(52) U.S. Cl. 433/93

(57) ABSTRACT

A dental isolation block adapted for maintaining the mouth of the dental patient open, while keeping the work field dry and exposed with the lip retracted and the tongue suppressed to facilitate performance of a dental procedure by a dental practitioner. The dental isolation block includes a first and second bite platform capable of being disposed between the maxillary arch and mandibular arch, a lip retractor with a first end adjacent the first bite platform and a second end adjacent the second bite platform, and a tongue shield extending between the first and second bite platform. The lip retractor may include a channel for receiving and directing saliva to a suction drain and suction holes all in fluid communication with a dental office suction system. A suction extension may be affixed to the first and/or second bite platform to further evacuate saliva from entering the work field. The dental isolation block can be positioned such that the lip retractor retracts the upper lip if the work field is on the upper arch or to retract the lower lip if the work field in on the lower arch.

This application claims the benefit of U.S. Provisional Patent Application Ser. No. 60/953,902, filed on Aug. 3, 2007, the disclosure of which is incorporated herein by reference as if fully set out at this point.

### BACKGROUND OF THE INVENTION

1. Field of the Invention

The present invention relates, generally, to bite block structures for dental procedures. More particularly, the present invention relates to bite block structures for holding the dental patient's mouth open such that the work field is exposed for the dental procedure.

2. Description of the Background Art

When a dental professional performs a dental procedure on a dental patient it is often necessary for the patient's mouth to be held open for access by the dental practitioner to the work field. For simple procedures, it may suffice for the patient to hold his or her mouth open. However, for more complex procedures, such as for the installation of implants or orthodontic devices, especially for children, it is not practical for the patient to hold his or her mouth open. For such dental procedures, the use of a dental bite block is frequently necessary in order to hold open the mouth of a patient.

Dental bite block devices are known in the art and include clamps, rubber dams or rolled pieces of rubber inserted between the upper and lower teeth. The problems encountered with such known devices are that they often fail to properly expose the work field or are very uncomfortable to the dental patient.

In addition, it is often necessary for the lip of the patient to be retracted away from the work field. This is particularly the case with the installation of orthodontic brackets on the teeth of a dental patient. In such instances, the help of a dental assistant is often required to retract the patient's lip(s) thereby requiring additional time, reducing efficiency, and introducing another set of hands into the work field which could also further reduce exposure.

It is also known that a dental patient's tongue may extend into the work field and thereby interfere with the dental procedure. The tongue may reduce the available work space and visibility in the work field and potentially introduce unwanted moisture. It is known that it is a common reflex when a dental patient's teeth are separated during a dental procedure for the tongue to extend into the work field particularly during swallowing. A need therefore exists for a bite block structure which provides exposure to a work field by holding the dental patient's mouth open while also simultaneously retracting the patient's lip and suppressing the tongue of the patient.

It is additionally known by those skilled in the art that many dental procedures require a dry work field in order to achieve a successful result. It is known that a large percentage of dental procedures fail, especially where chemical bonding is required, due to the presence of moisture in the work field. During a typical dental procedure, the oral cavity produces saliva which is known to commonly migrate into the work field and interfere with the bonding process. Other types of debris, such as water or blood are also known to migrate into the work field. As a result, an additional need exists in the art for a bite block device which provides the ability to evacuate such saliva and debris from the work field in order to reduce the possibility of failure of the dental procedure.

### SUMMARY OF THE INVENTION

The product of the present disclosed invention is a dental isolation bite block that can be attached to the suction hand piece to help maintain a dry work field during dental procedures. The device has a portion of the block that extends into the vestibule to help retract the lip and keep the teeth dry. It can be used on the maxillary or mandibular arches. In one embodiment is an autoclavable version that is reusable and composed of rubber. A second embodiment includes a disposable version that is composed of a light weight plastic. Three (or more) sizes for different size arches are contemplated

The dental isolation block of the present disclosure is designed to be bit between the upper and lower teeth of a dental patient during a dental procedure. The dental isolation block includes, generally at least one bite platform, a lip retractor extending from the bite platform for retracting the lip of the dental patient and thereby exposing the work field to the dental practitioner, and a tongue shield for suppressing the tongue of the dental patient from entering the work field. The lip retractor preferably includes at least one suction hole in fluid communication with a standard dental office suction system known in the art for evacuating saliva and other debris.

More particularly, the dental isolation block includes a first and second bite platform capable of being clenched between the maxillary (upper) and mandibular (lower) arches. The lip retractor includes a first end, adjacent the first bite platform and a second end adjacent the second bite platform. The lip retractor is preferably arcuate in geometry with a top edge including a channel therein for collecting saliva and other debris and directing it to a plurality of suction drains which are in fluid communication, via a series of internal passageways in the lip retractor to the first bite platform. The bottom edge of the lip retractor includes a plurality of suction holes to additionally evacuate saliva away from the work field. The first bite platform includes a suction attachment in fluid communication with the suction drains and suction holes. A suction extension may be attached to the first and/or second bite platform to evacuate saliva and other debris from the sublingual region. The suction extension(s) are in fluid communication with the dental office suction system. The dental isolation block thereby evacuates saliva where released in the mouth.

The lip retractor extends above and in front of the bite platforms and arcuates such that in operation, the lip retractor functions to retract the lip away from the work field. The dental isolation block may be positioned in the patient's mouth such that the lip retractor retracts the upper lip such as when the work field involves the maxillary (upper) arch or may be positioned in the patient's mouth such that the lip retractor retracts the lower lip such as when the work field involves the mandibular (lower) arch.

The lip retractor may also include indentations therein to accommodate the anatomy of the human mouth. Such indentations are positioned on the upper edge of the lip retractor so as to mate and accommodate the tissue connecting the lip to the gums.

A tongue shield extends between the first bite platform and the second bite platform. The tongue shield is shaped to comfortably suppress the tongue of the dental patient from extending into the work field during the dental procedure.

The dental isolation block of the present disclosure thereby maintains the work field dry and exposed to the dental practitioner. As a result, the need for assistance in maintaining the work field exposed and dry is thereby dramatically reduced thereby reducing time, effort and increasing efficiency. Moreover, the dental isolation block substantially reduces the failure rate of dental procedures that require dry conditions for success.

The present disclosure also includes a method of use of the disclosed dental isolation bite block to perform a dental procedure. The method includes the following steps:
a. Attaching an aspiration hose of the low volume dental suction system to the suction attachment;
b. placing the dental isolation block in the mouth of a dental patient such that the first and second bite platforms are disposed between the upper and lower arches;
c. directing the dental patient to bite on the first and second bite platforms;
d. positioning the lip retractor so as to retract the lip of the patent away from the work field;
e. activating a vacuum source of the dental office suction system so as to extract saliva and debris away from the work field;
f. performing a dental procedure on the dental patient in the work field.

A better understanding of the present invention, its several aspects, and its advantages will become apparent to those skilled in the art from the following detailed description, wherein there is described the preferred embodiment of the invention, simply by way of illustration of the best mode contemplated for carrying out the invention.

### BRIEF DESCRIPTION OF THE DRAWINGS

FIG. 1 is an isometric view of the dental isolation block of the present disclosure.

FIG. 2 is an alternate isometric view of the dental isolation block of the present disclosure.

FIG. 3 is a front view of the dental isolation block of the present disclosure depicting certain of the suction passageways in phantom.

FIG. 4 is a plan view of the dental isolation block of the present disclosure depicting certain of the suction passageways in phantom.

FIG. 5 is a partial cut away view of the dental isolation block of the present disclosure taken along line 5-5 of FIG. 3 depicting certain of the suction passageways in phantom.

FIG. 6 is a side view taken along line 6-6 of FIG. 3 of the dental isolation block of the present disclosure depicting certain of the suction passageways in phantom.

FIG. 7 is a back view of the dental isolation block of the present disclosure depicting certain of the suction passageways in phantom and an exemplary manner of installation of a suction extension onto the bite platform.

FIG. 8 depicts the dental isolation block of the present disclosure inserted in the mouth of a dental patient so as to expose the upper arch and retract the upper lip.

FIG. 9 depicts the dental isolation block of the present disclosure inserted in the mouth of a dental patient so as to expose the lower arch and retract the lower lip.

### DETAILED DESCRIPTION OF THE PREFERRED EMBODIMENTS

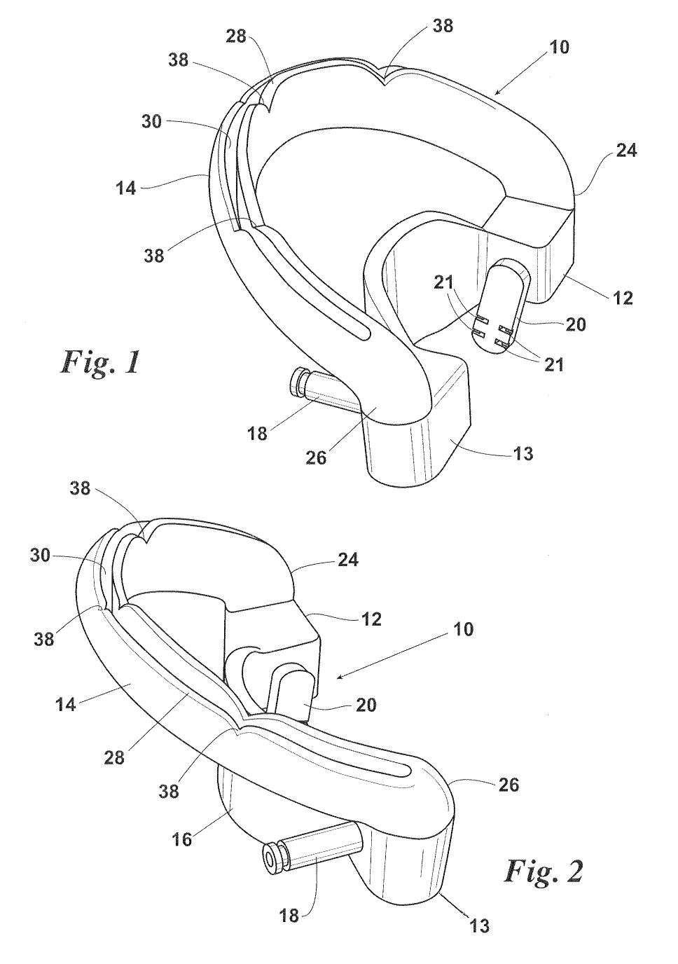

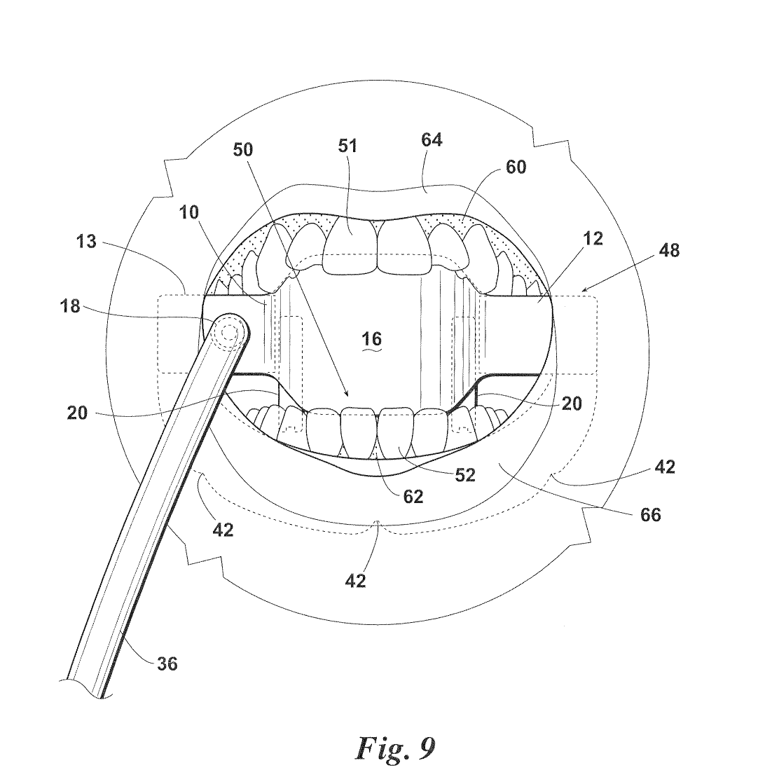

With reference to the figures, and particularly FIGS. 1 and 2, the dental isolation bite block of the present disclosure shall next be described. Dental isolation bite block 10 of the present disclosure includes, generally, first bite platform 12 and second bite platform 13 which are capable of being clenched between the maxillary (upper) and mandibular (lower) arches (60 and 62 of FIGS. 8 and 9). In the preferred embodiment, dental isolation block 10 is molded from a suitable medical grade silicone rubber, such as Elastosil® R-401 available commercially from Wacker Chemie AG, however, other suitable materials and manufacturing methods are contemplated.

In the preferred embodiment, a lip retractor 14 including a first end 24 and a second end 26 is attached to first bite platform 12 and second bite platform 13, respectively. In the preferred arrangement, first end 24 is adjacent and attached to first bite platform 12 and second end 26 is positioned adjacent to second bite platform 13. A tongue shield 16 extends between first bite platform 12 and second bite platform 13 and is molded integrally therewith. First end 24 is in the preferred embodiment affixed to first bite platform 12 and second end 26 is affixed to second bite platform 13 using a multi-purpose sealant. It has been found that multi-purpose sealant 732 available from Dow Corning® is a suitable sealant for this purpose, however, it is understood that alternate sealants are available commercially and can be substituted.

Lip retractor 14 includes an arcuate geometry such that lip retractor 14 extends from bite platforms 12 and 13 at first end 24 and second end 26, respectively, above and in front of bite platforms 12 and 13. Lip retractor 14 is arcuate so as to conform to the upper arch 60 and lower arch 62 (see FIGS. 8 and 9) and is capable of retracting either upper lip 64 (FIG. 8) or alternatively lower lip 66 (FIG. 9) as may be required for a particular dental procedure.

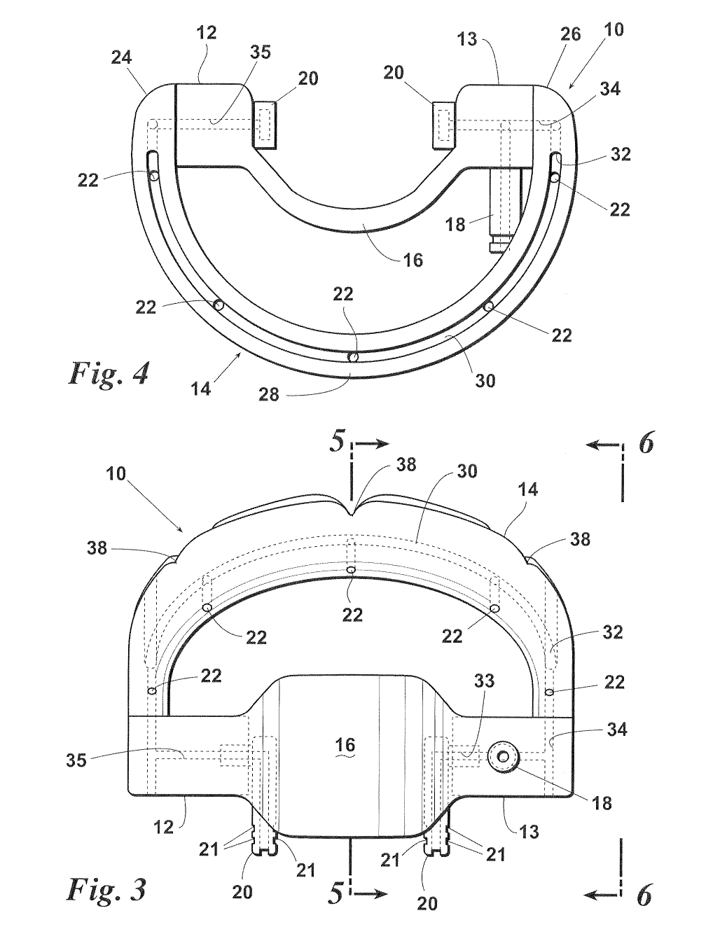

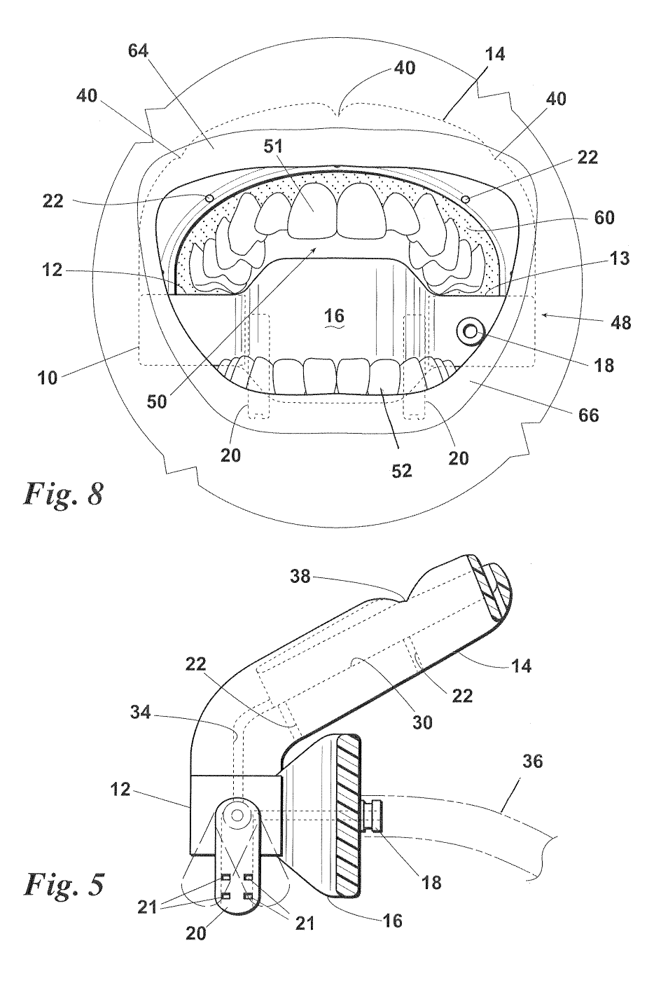

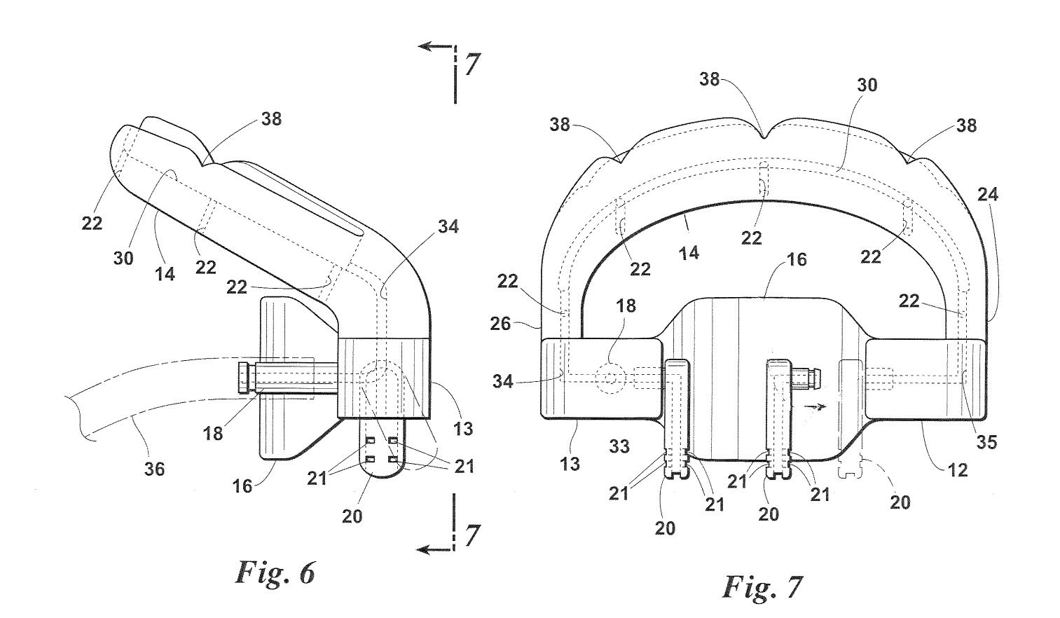

The top edge 28 of lip retractor 14 includes a channel 30 therein for collecting saliva and other debris during the dental procedure. Due to the geometry of lip retainer 14, coupled with the dental office suction system, saliva and debris collected in channel 30 is directed toward second end 26 where channel 30 terminates. With particular reference to FIG. 4, a plan view of dental isolation block 10, it can be seen that the saliva and debris is directed toward a suction drain 32 positioned within channel 30 adjacent second end 26 so as to evacuate the saliva and debris from the work field. Taking FIG. 4 in combination with FIGS. 3, 5, 6, and 7, it can be seen that suction drain 32 is in fluid communication, via interior passageway 34, to a suction attachment 18 on second bite platform 13. Suction attachment 18 extends from second bite platform 13 so as to receive an aspiration hose 36. Aspiration hose 36 is not part of the present invention but is rather a standard part of a dental office suction system known and commonly employed in the dental industry. In the preferred embodiment, suction attachment 18 is in fluid communication with the low volume suction system of the dental office.

Referring to FIG. 3 taken in combination with FIGS. 4, 5, 6, and 7, lip retractor 14 includes a plurality of suction holes 22 spaced around its arcuate length in order to additionally evacuate saliva away from the work field. Suction holes 22 are in fluid communication with channel 30, suction drains 32, fluid passageway 34, and suction outlet 18. In the preferred embodiment, a suction extension 20 may be attached to the second bite platform 13. Suction extension 20 is in fluid communication with suction outlet 18 through passageway 33 extending through second bite block 13. Suction extension 20 includes a plurality of holes 21 in order to evacuate sublingual saliva and debris. A second suction extension 20 may be inserted in first bite platform 12 and include holes 21 therein. The suction extension 20 inserted in first bite platform 12 is identical to suction extension 20 inserted in second bite platform 13 in the preferred embodiment. Suction extension 20 inserted in first bite platform 12 is in fluid communication with the suction system via passageway 35 which extends through first bite platform 12 and into lip retractor 14 through first end 24. FIG. 7 depicts the manner in which suction extensions 20 are secured to first bite platform 12 and second bite platform 13. Suction extensions 20 are pivotal in relation to first bite platform 12 and second bite platform 13 respectively so as to facilitate the sublingual evacuation of saliva and debris as necessary to maintain a dry work field.

Lip retractor 14 further includes indentations 38 therein to accommodate the anatomy of the human mouth. Indentations 38 are positioned on the upper edge 28 of lip retractor 14 so as to mate and accommodate the frenula tissue connecting the human lip to the gums. FIG. 8 illustrates such labial frenulum tissue segments 40 in phantom for upper lip 64 while FIG. 9 illustrates lingual frenum tissue segments 42 for lower lip 66. Indentations 38 provide additional comfort to lip retractor 14 and dental isolation bite block 10 of the present disclosure.

Tongue shield 16 extends between first bite platform 12 and second bite platform 13. Tongue shield 16 includes a convex curve in the direction of lip retractor 14 so as to comfortably shield the tongue of the dental patient and suppress it from extending into the work field during the dental procedure.

Referring next to FIG. 8, a method of using the dental isolation block of the present disclosure shall be described:

A method of performing a dental procedure on a work field of dental patient having upper teeth (collectively 51) and lower teeth (collectively 52) using a dental isolation block having a first bite platform 12 and a second bite platform 13, an arcuate lip retractor 14 extending between the first bite platform 12 and second bite platform 13 wherein lip retractor 14 includes a channel and a plurality of suction holes 22 in fluid communication with suction attachment 18 and in further fluid communication with a dental office suction system and a tongue shield 16 extending between the first bite platform 12 and the second bite platform 13; said method comprising:
a.) attaching an aspiration hose 36 of the dental office suction system to the suction attachment 18;
b.) placing dental isolation block 10 in the mouth 48 of a dental patient such that first bite platform 12 and second bite platform 13 are disposed between upper arch 60 and lower arch 62;
c.) directing the dental patient to bite on the first bite platform 12 and second bite platform 13;
d.) positioning lip retractor 14 so as to retract the lip (64 or 66) of the patient away from the work field 50;
e.) activating the vacuum source of the dental office suction system so as to extract saliva and debris away from work field 50;
f.) performing a dental procedure on the dental patient in work field 50.

FIG. 8 depicts the dental isolation block 10 of the present disclosure positioned such that lip retractor 14 retracts upper lip 64. In this orientation, dental isolation bite block 10 exposes and provides a dry work field 50 for upper maxillary arch 60. FIG. 9 depicts the dental isolation bite block 10 of the present disclosure oriented so as to retract lower lip 66. In this orientation, dental isolation block 10 of the present disclosure provides an exposed and dry work field 50 for lower mandibular arch 62.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A dental isolation block for use in combination with a dental office suction system, comprising:
at least one bite platform;
a lip retractor extending form said at least one bite platform for retracting the lip of a dental patient;
said lip retractor including at least one suction hole in fluid communication with the dental office suction system.

2. The dental isolation block of claim 1 wherein said lip retractor includes a plurality of suction holes each in fluid communication with the dental office suction system.

3. The dental isolation block of claim 1 wherein said dental office suction system includes an aspiration hose and the dental isolation block includes a dental office suction attachment in fluid communication with said at least one suction hole for receiving the aspiration hose.

4. The dental isolation block of claim 1 wherein said lip retractor is arcuate in geometry and includes a channel therein.

5. The dental isolation block of claim 4 wherein said channel includes at least one suction drain in fluid communication with the dental office suction system.

6. The dental isolation block of claim 1 further includes at least one suction extension attached to said at least one bite platform and in fluid communication with the dental office suction system.

7. The dental isolation block of claim 1 further including a tongue shield extending from said at least one bite platform.

8. The dental isolation block of claim 4 wherein said lip retractor includes at least one lip retractor to mate the frenula tissue connecting the upper lip to the gums.

9. A dental isolation block for use with a dental patient having upper and lower arches comprising:
a first and second bite platform capable of being disposed between the upper and lower arch;
a lip retractor having a first end adjacent said first bite platform and a second end adjacent said second bite platform;
a tongue shield extending between said first and second bite platform.

10. The dental isolation block of claim 9 for use with a dental office suction system wherein said lip retractor includes at least one suction hole in fluid communication with the dental office suction system.

11. The dental isolation block of claim 10 wherein said lip retractor includes a plurality of suction holes each in fluid communication with the dental office suction system.

12. The dental isolation dock of claim 10 wherein the dental office suction system includes an aspiration hose and the dental isolation block includes a suction attachment in fluid communication with said plurality of suction holes.

13. The dental isolation block of claim 9 wherein said lip retractor is arcuate in geometry and extends above and outward from said first and second bite platform.

14. The dental isolation block of claim 13 wherein said lip retractor includes a channel having at least one suction drain in fluid communication with the suction system.

15. The dental isolation block of claim 13 wherein said lip retractor includes at least one indentation positioned therein to mate the tissue connecting the lip to the gums.

16. The dental isolation block of claim 10 includes a suction extension attached to said first bite platform and in fluid communication with the dental office suction system.

17. The dental isolation block of claim 16 further including a second suction extension attached to said suction bite platform and in fluid communication with the dental office suction system.

18. A method of performing a dental procedure on a work field of dental patient having upper and lower teeth using a dental isolation block having a first and a second bite platform, an arcuate lip retractor extending between the first and second bite platform wherein the lip retractor includes a plurality of suction holes in fluid communication with a suction attachment in further fluid communication with a dental office suction system and a tongue shield extending between the first and second bite platform in said method comprising:
a.) attaching an aspiration hose of the dental office suction system to the suction attachment;
b.) placing said dental isolation block in the mouth of a dental patient such that the first and second bite platforms are disposed between the upper and lower arches;
c.) directing the dental patient to bite on the first and second bite platforms;
d.) positioning the lip retractor so as to retract the lip of the patient away from the work field;
e.) activating a vacuum source of the dental office suction system so as to extract saliva and debris away from the work field;
f.) performing a dental procedure on the dental patient in the work field.

19. The method of claim 18 wherein the work field is on the upper arch of the dental patient and lip retractor is positioned to retract the upper lip.

20. The method of claim 18 wherein the work field is on the lower arch of the dental patient and the lip retractor is positioned to retract the lower lip.
